(19) United States
(12) Patent Application Publication
(10) Pub. No.: US 2018/0355872 A1
(43) Pub. Date: Dec. 13, 2018

(54) METER-TYPE MAGNETIC PUMP AND MEASURING MODULE THEREOF

(71) Applicant: TAIKO INVESTMENT CO.,LTD., New Taipei City (TW)

(72) Inventors: Po-Han Chang, New Taipei City (TW); Shu-Hong Lin, New Taipei City (TW); Tien-Ho Wu, New Taipei City (TW)

(21) Appl. No.: 15/621,020

(22) Filed: Jun. 13, 2017

(30) Foreign Application Priority Data
Jun. 8, 2017 (CN) 201710427595.2

(51) Int. Cl. F04D 15/00; F04D 13/06; F04D 29/40; F04C 2/14; F04C 14/28; F04C 15/00; F04C 14/08; G01F 1/66

(52) U.S. Cl. CPC F04D 15/0066; F04D 13/06; F04D 15/0088; F04D 29/406; G01F 1/661; F04C 14/28; F04C 15/008; F04C 14/08; F04C 2/14

(57) ABSTRACT

A meter-type magnetic pump and its light interrupting module achieve flow measurement by providing a main cavity body having a light interrupter at the inner side of a first cavity, and providing at least a light interrupting element in the first cavity and fastened around the rotating shaft, such that the light interrupting element is brought into rotation by the rotating shaft, wherein the at least one light interrupting blade of the at least one light interrupting element periodically interrupts a light source provided by the light interrupter, allowing the light interrupter to generate at least one signal, electrically coupling the control circuit with the light interrupter to receive the at least one signal and perform a measuring process.

### FIELD OF THE INVENTION

The present invention relates to a meter-type magnetic pump and a measuring module thereof, and more particularly, to a meter-type magnetic pump for flow measurement and a light interrupting module thereof.

### BACKGROUND OF THE INVENTION

During operation of a traditional micro-pump, in order to control the flow of water in and out of the pump, an external flowmeter is typically connected to control the flow. However, using an external flowmeter to control the flow, the working frequencies of the micro-pump and flowmeter have to be calculated, so that the two can be matched in the operation process. If the two cannot match in operation, it will lead to inability to control flow or control instability. Moreover, the use of micro-pump with an external flowmeter, in addition to having to calculate the working frequencies of the two, has shortcomings such as larger number of components and increased cost increases.

In addition, in order to improve the conventional micro-pumps, some manufacturers have designed the flowmeter inside the structure of the micro-pump. This results in the increase of the internal components and a more complicated micro-pump structure, increasing the number of components and the cost of the micro-pump instead of reducing them.

Furthermore, in order to improve the conventional micro-pumps, the micro-pump is designed to be of a diaphragm-type, in which circular motion is provided by a motor, and then the diaphragm inside the micro-pump performs reciprocating movements through a mechanical device, which results in compression and drawing of air inside the micro-pump cavity. Through a one-way valve, a pressure difference is produced between the outlet or the inlet of the micro-pump and the atmospheric pressure outside. Due to this pressure difference, water is compressed into the inlet, and then discharged from the outlet, so that such micro-pumps are particularly suitable in products such as small appliances and medical equipment, but it is still difficult to accurately control the flow.

Therefore, there is a need in the industry for a solution that addresses the shortcomings associated with flow control of conventional micro-pumps.

### SUMMARY OF THE INVENTION

In view of the background of the invention and requirements in the industry, the present invention provides a meter-type magnetic pump and its measuring module to address the shortcomings of the prior art.

An objective of the present invention is to achieve measurement of flow by including a main cavity body having a first cavity, a penetrating hole provided at one end of the main cavity body, and a first opening provided at the other end of the main cavity body, passing a rotating shaft of a motor through the penetrating hole, providing a light interrupter at the inner side of the first cavity, and providing at least a light interrupting element in the first cavity and fastened around the rotating shaft, such that the light interrupting element is brought into rotation by the rotating shaft, wherein the at least one light interrupting blade of the at least one light interrupting element periodically interrupts a light source provided by the light interrupter, allowing the light interrupter to generate at least one signal, electrically coupling the control circuit with the light interrupter to receive the at least one signal and perform a measuring process, providing at least one first magnetic element in the first cavity and fastened around the rotating shaft, and then placing a partition at the first opening of the main cavity body with a first recess provided in the center of one end of the partition, providing a cover at one end of the partition with a second cavity located at the inner side of the cover, an inlet located at the top end thereof, an outlet located at a side thereof, and a third recess located at one end of the inner side thereof, the third recess corresponding to the first recess, providing an impeller set inside the second cavity of the cover for stirring fluid, placing a second magnetic element inside the second cavity of the cover for receiving the magnetic force of the first magnetic element to generate the kinetic energy; and placing a central shaft inside the second cavity of the cover around which the rotating element and the second magnetic element are fastened with one end of the central shaft disposed in the first recess and the other end disposed in the third recess.

According to the above objective, a meter-type magnetic pump of the present invention may include: a main cavity body having a first cavity, a penetrating hole provided at one end of the main cavity body, and a first opening provided at the other end of the main cavity body; a motor including a rotating shaft passing through the penetrating hole; a light interrupter provided at the inner side of the first cavity; at least a light interrupting element provided in the first cavity and fastened around the rotating shaft, such that the light interrupting element is brought into rotation by the rotating shaft, wherein the at least one light interrupting element includes at least one light interrupting blade for periodically interrupting a light source provided by the light interrupter and allowing the light interrupter to generate at least one signal; a control circuit electrically coupled with the light interrupter to receive the at least one signal and perform a measuring process; at least a first magnetic element disposed in the first cavity and fastened around the rotating shaft; a partition disposed at the first opening of the main cavity body with a first recess provided in the center of one end of the partition; a cover provided at one end of the partition with a second cavity provided at the inner side thereof, an inlet at the top end thereof, an outlet at a side thereof, and a third recess at one end of the inner side thereof, the third recess corresponding to the first recess; a rotating element disposed inside the second cavity of the cover for stirring fluid; a second magnetic element disposed inside the second cavity of the cover for receiving a magnetic force of the first magnetic element to generate kinetic energy; and a central shaft disposed inside the second cavity of the cover around which the rotating element and the second magnetic element are fastened, wherein one end thereof is disposed in the first recess, and the other end thereof is disposed in the third recess.

According to another aspect of the present invention, the at least one light interrupting blade includes two light interrupting blades, the angle between the two light interrupting blades is 180°, which is the light source interrupting period of the light interrupter.

According to another aspect of the present invention, the at least one light interrupting blade includes three light interrupting blades, the angle between any two light interrupting blades is 120°, which is the light source interrupting period of the light interrupter.

According to another aspect of the present invention, the at least one light interrupting blade four two light interrupting blades, the angle between any two light interrupting blades is 90°, which is the light source interrupting period of the light interrupter.

According to another aspect of the present invention, the rotating element further includes an impeller set or a gear set.

According to another aspect of the present invention, the control circuit performs the measuring process to generate a control signal and controls the actuation of the rotating element to facilitate regulation of the amount of fluid released.

According to another objective, a measuring module for a magnetic pump of the present invention may include: a light interrupter provided at the inner side of a first cavity of a main cavity body of the magnetic pump, wherein a rotating shaft passes through a penetrating hole provided at one end of the main cavity body, and a first opening is provided at the other end of the main cavity body; at least a light interrupting element that is brought into rotation by the rotating shaft in the first cavity to interrupt a light source provided by the light interrupter at a specific period and allowing the light interrupter to generate at least one periodic signal based on periodic change of light source interruption; and a control circuit electrically coupled with the light interrupter to receive the at least one signal and perform a measuring process.

According to another aspect of the present invention, the specific period is calculated from rotation angle of the rotating shaft, wherein the specific period further includes 360°, 180°, 120° and 90°.

According to another aspect of the present invention, the at least one light interrupting element further includes at least one light interrupting blade for interrupting the light source of the light interrupter during rotation, wherein the at least one light interrupting blade is arranged on the rotating shaft based on the quantity required for achieving the specific period.

According to another aspect of the present invention, the magnetic pump further includes: a motor for rotating the rotating shaft; at least a first magnetic element disposed in the first cavity and fastened around the rotating shaft, wherein the first magnetic element is brought into motion by the rotating shaft; a partition disposed at the first opening of the main cavity body with a first recess provided in the center of one end of the partition; a cover provided at one end of the partition with a second cavity provided at the inner side thereof, an inlet at the top end thereof, and an outlet at a side thereof, wherein a third recess is disposed at one end of the inner side thereof, and the third recess corresponds to the first recess; a magnetic rotating module disposed inside the second cavity of the cover for stirring fluid and receiving a magnetic force of the at least one first magnetic element to generate kinetic energy; and a central shaft disposed inside the second cavity of the cover around which the rotating element and the magnetic rotating module are fastened, wherein one end thereof is disposed in the first recess, and the other end thereof is disposed in the third recess.

According to another aspect of the present invention, the magnetic rotating module further includes an impeller set or a gear set.

According to another aspect of the present invention, the magnetic rotating module further includes at least one second magnetic element disposed in the second cavity of the cover for receiving the magnetic force of the at least one first magnetic element to generate kinetic energy.

According to yet another objective, a meter-type magnetic pump of the present invention may include: a main cavity body having a first cavity, a penetrating hole provided at one end of the main cavity body, and a first opening provided at the other end of the main cavity body; a motor including a rotating shaft passing through the penetrating hole; at least a first magnetic element disposed in the first cavity and fastened around the rotating shaft; a measuring device that is brought into motion by the rotation of the rotating shaft, such that interruption or passing through of a light source is performed at a specific period, and the measuring device generates a signal based on the specific period in order to performs a measuring process; a partition disposed at the first opening of the main cavity body with a first recess provided in the center of one end of the partition; a cover provided at one end of the partition with a second cavity provided at the inner side thereof, an inlet at the top end thereof, an outlet at a side thereof, and a third recess at one end of the inner side thereof, the third recess corresponding to the first recess; a rotating element disposed inside the second cavity of the cover for stirring fluid; a magnetic rotating module disposed inside the second cavity of the cover for stirring fluid and receiving a magnetic force of the at least one first magnetic element to generate kinetic energy; and a central shaft disposed inside the second cavity of the cover around which the rotating element and the magnetic rotating module are fastened, wherein one end thereof is disposed in the first recess, and the other end thereof is disposed in the third recess.

According to another aspect of the present invention, the measuring device further includes: a light interrupter provided at the inner side of the first cavity; at least a light interrupting element that is brought into rotation by the rotating shaft to interrupt the light source provided by the light interrupter at a specific period to allow the light interrupter to generate the signal based on the specific period for light source interruption; and a control circuit electrically coupled with the light interrupter to receive the periodic signal and perform the measuring process.

According to another aspect of the present invention, the specific period is calculated from rotation angle of the rotating shaft, wherein the specific period further includes 360°, 180°, 120° and 90°.

According to another aspect of the present invention, the at least one light interrupting element further includes at least one light interrupting blade for interrupting the light source of the light interrupter during rotation, wherein the at least one light interrupting blade is arranged on the rotating shaft based on the quantity required for achieving the specific period.

According to another aspect of the present invention, the control circuit performs the measuring process to generate a control signal and controls the actuation of the magnetic rotating module to facilitate regulation of the amount of fluid released.

According to another aspect of the present invention, the magnetic rotating module further includes an impeller set or a gear set.

According to another aspect of the present invention, the magnetic rotating module further includes at least one second magnetic element disposed in the second cavity of the cover for receiving the magnetic force of the at least one first magnetic element to generate kinetic energy.

### BRIEF DESCRIPTION OF THE DRAWINGS

FIG. 1 is a schematic diagram illustrating a meter-type magnetic pump in accordance with an embodiment of the present invention.

FIGS. 2A to 2D are schematic diagrams showing various quantities of light interrupting elements and actuation thereof in accordance with the present invention.

### DETAILED DESCRIPTION OF THE INVENTION

The present invention is directed to a meter-type magnetic pump and its measuring module. Detailed structures and their components and methods are provided in the following description to facilitate a thorough understanding of the present invention. It can be appreciated that the implementations of the present invention are not limited to specific details known to those with ordinary skill in the art of meter-type magnetic pump and its measuring module. On the other hand, well-known structures and their components are not described in details to avoid unnecessarily imposing limitations on the present invention. Moreover, in order to provide a clear descriptions and for those with ordinary skill in the art to fully understand technical contents of the present invention, some portions of the drawings are not relatively drawn to scale; ratios of some compared to other dimensions may be exaggerated, and irrelevant details may be omitted for concise drawings. Preferred embodiments of the present invention are described in details below. Nonetheless, in addition to these details descriptions, the present invention can be broadly applied to other embodiments, and the present invention is not limited by them, but rather by the scope delineated in the appended claims.

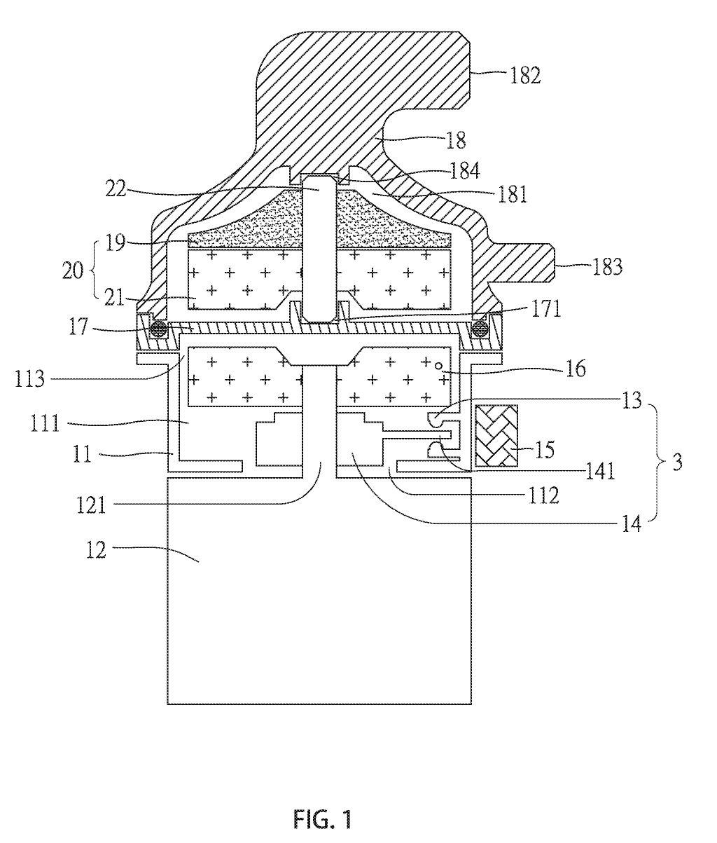

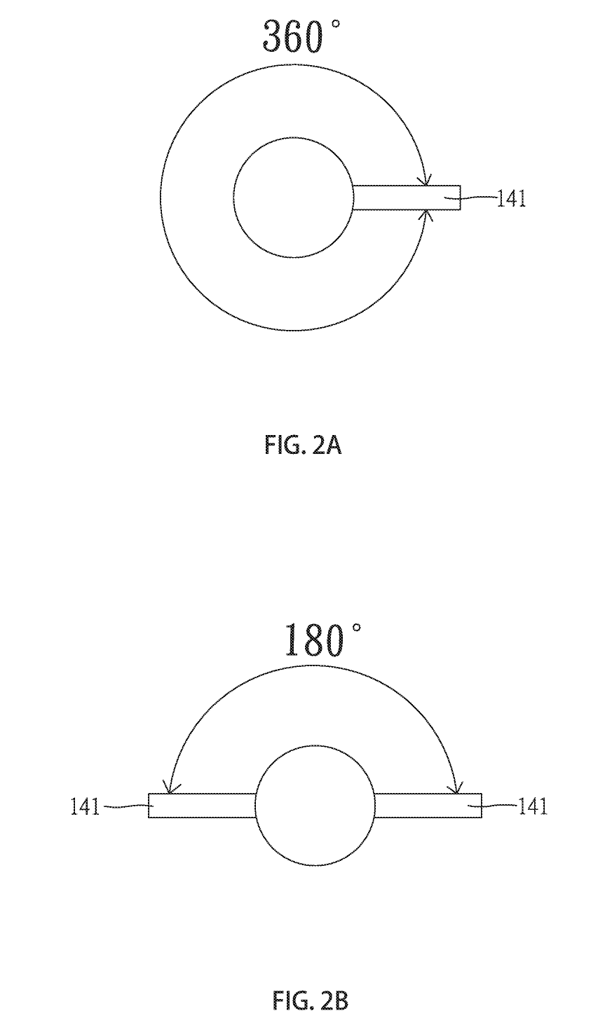

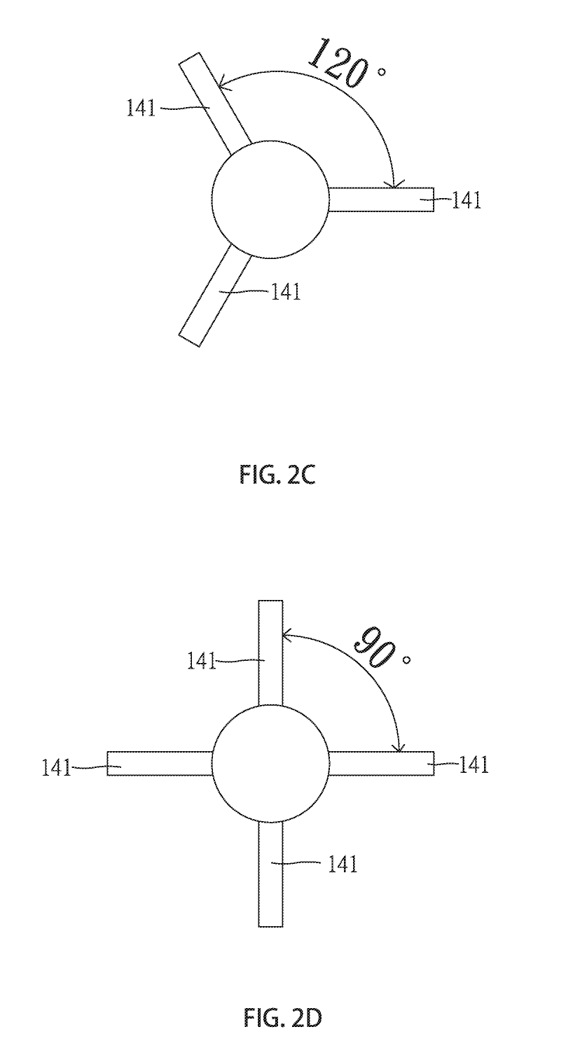

Referring to FIGS. 1 to 2D, a meter-type magnetic pump in accordance with an embodiment of the present invention is shown. The meter-type magnetic pump essentially includes: a main cavity body 11 having a first cavity 111, a penetrating hole 112 provided at one end of the main cavity body 11, and a first opening 113 provided at the other end of the main cavity body 11; a motor 12 including a rotating shaft 121 passing through the penetrating hole 112; a light interrupter 13 provided at the inner side of the first cavity 111; at least a light interrupting element 14 provided in the first cavity 111 and fastened around the rotating shaft 121 such that the light interrupting element 14 is brought into rotation by the rotating shaft 121, wherein the at least one light interrupting element 14 includes at least one light interrupting blade 141 for periodically interrupting the light source provided by the light interrupter 13 and allowing the light interrupter 13 to generate at least one signal; a control circuit 15 electrically coupled with the light interrupter 13 to receive the at least one signal and perform a measuring process; at least a first magnetic element 16 disposed in the first cavity 111 and fastened around the rotating shaft 121; a partition 17 disposed at the first opening 113 of the main cavity body 11 with a first recess 171 provided in the center of one end of the partition 17; a cover 18 provided at one end of the partition 17 with a second cavity 181 provided at the inner side of the cover 18, an inlet 182 provided at the top end thereof, an outlet 183 at a side thereof, and a third recess 184 at one end of the inner side thereof, the third recess 184 corresponding to the first recess 171; a rotating element 19 disposed inside the second cavity 181 of the cover 18 for stirring fluid; a second magnetic element 21 disposed inside the second cavity 181 of the cover 18 for receiving a magnetic force of the first magnetic element 16 to generate kinetic energy; and a central shaft 22 disposed inside the second cavity 181 of the cover 18 around which the rotating element 19 and the second magnetic element 21 are fastened, and one end thereof disposed in the first recess 171, and the other end thereof disposed in the third recess 184.

According to the present embodiment, when the at least one light interrupting blade 141 includes two light interrupting blades 141, the angle between the two light interrupting blades 141 is 180°, which is the light interrupting period of the light interrupter 13.

According to the present embodiment, when the at least one light interrupting blade 141 includes three light interrupting blades 141, the angle between any two light interrupting blades 141 is 120°, which is the light interrupting period of the light interrupter 13.

According to the present embodiment, when the at least one light interrupting blade 141 includes four light interrupting blades 141, the angle between any two light interrupting blades 141 is 90°, which is the light interrupting period of the light interrupter 13.

According to the present embodiment, the rotating element 19 further includes an impeller set or a gear set.

According to the present embodiment, the control circuit 15 performs the measuring process to generate a control signal and controls the actuation of the rotating element 19 to facilitate regulation of the amount of fluid released.

During operation of the meter-type magnetic pump in accordance with the present invention, the motor 12 operates and causes the rotating shaft 121 to rotate, and the rotating shaft 121 passes through the penetrating hole 112 of the main cavity body 11 to be in the first cavity 111 of the rotating shaft 121. While the rotating shaft 121 is rotating, the at least one light interrupting element 14 and the at least one first magnetic element 16 fastened around the rotating shaft 121 are brought into motion, wherein the at least one light interrupting blade 141 of the light interrupting element 14 periodically interrupts the light source of the light interrupter 13 at the inner side of the first cavity 111, causing the light interrupter 13 to generate a signal.

Furthermore, referring to FIGS. 2A to 2D, when the at least one light interrupting blade 141 includes two light interrupting blades 141, the angle between the two light interrupting blades 141 is 180°, which is the light interrupting period of the light interrupter 13; alternatively, when the at least one light interrupting blade 141 includes three light interrupting blades 141, the angle between any two light interrupting blades 141 is 120°, which is the light interrupting period of the light interrupter 13; and alternatively, when the at least one light interrupting blade 141 includes four light interrupting blades 141, the angle between any two light interrupting blades 141 is 90°, which is the light interrupting period of the light interrupter 13.

The signal generated by the light interrupter 13 is received by the control circuit 15 electrically coupled with the light interrupter 13, and then the control circuit 15 performs the measuring process to generate a control signal. The control signal controls the actuation of the rotating element 19 to facilitate regulation of the amount of fluid released. Moreover, when the rotating shaft 121 is rotating, it also causes the at least one first magnetic element 16 to rotate, such that the at least one first magnetic element 16 rotates within the first cavity 111.

In this embodiment, the light interrupter 13, the at least one light interrupting element 14, and the control circuit 15 can be combined to form a measuring device 3. With the rotation of the measuring device 3, interrupting/passing of light at specific period is achieved. The measuring device generates the signal according to the specific period to perform the measuring process.

The partition 17 is disposed at the first opening 113 of the main cavity body 11. The first recess 171 is located in the center of one end of the partition 17, and the cover 18 is provided at one end of the partition 17. The second cavity 181 is provided at the inner side of the cover 18. The inlet 182 is provided at the top end of the cover 18 and the outlet 183 is provided at a side thereof. The third recess 184 is disposed at one end of the inner side (i.e. the second cavity 181) of the cover 18, such that the third recess 184 corresponds to the first recess 171.

Furthermore, a second recess 172 is provided around the periphery of the partition 17. A waterproof member 23 is provided inside the second recess 172.

The rotating element 19, the second magnetic element 21 and the central axis 22 are provided in the second cavity 181, wherein the rotating element 19 (i.e. an impeller set or a gear set) is used for stirring fluid flowing from the inlet 182 into the second cavity 181, so as to allow the fluid to flow out from the second cavity 181 via the outlet 183. The second magnetic element 21 receives the magnetic force from the at least one first magnetic element 16 to generate the kinetic energy. The central shaft 22 is inserted into the rotating element 19 and the second magnetic element 21. One end of the central shaft 22 is disposed in the first recess 171, and the other end thereof is disposed in the third recess 184.

Moreover, in this embodiment, the rotating element 19 and the second magnetic element 21 can be combined to form a magnetic rotating module 20. The magnetic rotating module 20 is provided within the second cavity 181 of the cover 18, wherein the magnetic rotating module 20 is magnetically coupled to the first magnetic element 16 via the second magnetic element 21. This causes the rotating element 19 to simultaneously rotate in the same direction as the first magnetic element 16 in order to stir fluid.

Referring to FIG. 1, a measuring module for a magnetic pump in accordance with another embodiment of the present invention is shown. The magnetic pump essentially includes: a light interrupter 13 provided in the inner side of a first cavity 111 of a main cavity body 11 of the magnetic pump, wherein a rotating shaft 121 passes through a penetrating hole 112 provided at one end of the main cavity body 11, and a first opening 113 is provided at another end of the main cavity body 11; at least a light interrupting element 14 that is brought to rotate by the rotating shaft 121 of the first cavity 111 for interrupting a light source of the light interrupter 13 at a specific period, such that the light interrupter 13 generates at least one periodic signal based on periodic changes of light source interruption; a control circuit 15 electrically coupled with the light interrupter 13 for receiving the at least one signal and performing a measuring process.

According to this embodiment, the specific period is calculated from rotation angle of the rotating shaft 121, wherein the specific period further includes 360°, 180°, 120° and 90°.

According to the present embodiment, the at least one light interrupting element 14 further includes at least one light interrupting blade 141 for interrupting the light source of the light interrupter 13 during rotation, wherein the at least one light interrupting blade 141 is arranged on the rotating shaft 121 based on the quantity required for achieving the specific period.

According to the present embodiment, the magnetic pump further includes a motor 12 for rotating the rotating shaft 121; a partition 17 disposed at the first opening 113 of the main cavity body 11 with a first recess 171 provided in the center of one end of the partition 17; a cover 18 provided at one end of the partition 17 with a second cavity 181 provided at the inner side of the cover 18, an inlet 182 provided at the top end thereof, an outlet 183 at a side thereof, and a third recess 184 at one end of the inner side thereof, the third recess 184 corresponding to the first recess 171; a rotating element 19 disposed inside the second cavity 181 of the cover 18 for stirring fluid; at least one first magnetic element 16 disposed in the first cavity 111 and fastened to the rotating shaft 121, such that the rotating shaft 121 causes the first magnetic element 16 to move; at least one second magnetic element 21 disposed inside the second cavity 181 of the cover 18 for receiving a magnetic force of the at least one first magnetic element 16 to generate kinetic energy; and a central shaft 22 disposed inside the second cavity 181 of the cover 18 around which the rotating element 19 and the second magnetic element 21 are fastened, and one end thereof disposed in the first recess 171, and the other end thereof disposed in the third recess 184.

According to this embodiment, the rotating element 19 further includes an impeller set or a gear set for stirring fluid.

The measuring module for a magnetic pump of this embodiment operates in similar ways as the previous embodiment of meter-type magnetic pump, so it will not repeated herein.

From the above, it can be seen that the meter-type magnetic pump and its light interrupting module in accordance with the present invention achieves measuring of flow by including the main cavity body 11 having the first cavity 111, the penetrating hole 112 provided at one end of the main cavity body 11, and the first opening 113 provided at the other end of the main cavity body 11, passing the rotating shaft 121 of the motor 12 through the penetrating hole 112, providing a light interrupter 13 at the inner side of the first cavity 111, and providing at least a light interrupting element 14 in the first cavity 111 and fastened around the rotating shaft 121, such that the light interrupting element 14 is brought into rotation by the rotating shaft 121, wherein the at least one light interrupting blade 141 of the at least one light interrupting element 14 periodically interrupts the light source provided by the light interrupter 13, allowing the light interrupter 13 to generate at least one signal, electrically coupling the control circuit 15 with the light interrupter 13 to receive the at least one signal and perform a measuring process, providing the at least one first magnetic element 16 in the first cavity 111 and fastened around the rotating shaft 121, and then placing the partition 17 at the first opening 113 of the main cavity body 11 with a first recess 171 provided in the center of one end of the partition 17, providing the cover 18 at one end of the partition 17 with a second cavity 181 located at the inner side of the cover 18, an inlet 182 located at the top end thereof, an outlet 183 located at a side thereof, and a third recess 184 located at one end of the inner side thereof, the third recess 184 corresponding to the first recess 171, providing the rotating element 19 inside the second cavity 181 of the cover 18 for stirring fluid, placing the second magnetic element 21 inside the second cavity 181 of the cover 18 for receiving the magnetic force of the first magnetic element 16 to generate the kinetic energy; and placing the central shaft 22 inside the second cavity 181 of the cover 18 around which the rotating element 19 and the second magnetic element 21 are fastened with one end thereof disposed in the first recess 171 and the other end thereof disposed in the third recess 184.

It is obvious that in light of the foregoing descriptions of the embodiments, numerous modifications and differences from the present invention may exist. The present invention should be construed within the scope of the claims. In addition to the detailed descriptions above, the present invention can be broadly implemented in other embodiments. The descriptions above are merely preferred embodiments of the present invention, and they are not intended to define the claimed scope of the present invention in any way. Other equivalent changes or modifications made without departing from the spirit disclosed by the present invention are to be construed as within the scope of the appended claims.

What is claimed is:

1. A meter-type magnetic pump comprising:
a main cavity body having a first cavity, a penetrating hole provided at one end of the main cavity body, and a first opening provided at the other end of the main cavity body;
a motor including a rotating shaft passing through the penetrating hole;
a light interrupter provided at the inner side of the first cavity;
at least a light interrupting element provided in the first cavity and fastened around the rotating shaft, such that the light interrupting element is brought into rotation by the rotating shaft, wherein the at least one light interrupting element includes at least one light interrupting blade for periodically interrupting a light source provided by the light interrupter and allowing the light interrupter to generate at least one signal;
a control circuit electrically coupled with the light interrupter to receive the at least one signal and perform a measuring process;
at least a first magnetic element disposed in the first cavity and fastened around the rotating shaft;
a partition disposed at the first opening of the main cavity body with a first recess provided in the center of one end of the partition;
a cover provided at one end of the partition with a second cavity provided at the inner side thereof, an inlet at the top end thereof, an outlet at a side thereof, and a third recess at one end of the inner side thereof, the third recess corresponding to the first recess;
a rotating element disposed inside the second cavity of the cover for stirring fluid;
a second magnetic element disposed inside the second cavity of the cover for receiving a magnetic force of the first magnetic element to generate kinetic energy; and
a central shaft disposed inside the second cavity of the cover around which the rotating element and the second magnetic element are fastened, wherein one end thereof is disposed in the first recess, and the other end thereof is disposed in the third recess.

2. The meter-type magnetic pump of claim 1, wherein the at least one light interrupting blade includes two light interrupting blades, the angle between the two light interrupting blades is 180°, which is the light source interrupting period of the light interrupter.

3. The meter-type magnetic pump of claim 1, wherein the at least one light interrupting blade includes three light interrupting blades, the angle between any two light interrupting blades is 120°, which is the light source interrupting period of the light interrupter.

4. The meter-type magnetic pump of claim 1, wherein the at least one light interrupting blade four two light interrupting blades, the angle between any two light interrupting blades is 90°, which is the light source interrupting period of the light interrupter.

5. The meter-type magnetic pump of claim 1, wherein the rotating element further includes an impeller set or a gear set.

6. The meter-type magnetic pump of claim 1, wherein the control circuit performs the measuring process to generate a control signal and controls the actuation of the rotating element to facilitate regulation of the amount of fluid released.

7. A measuring module for a magnetic pump comprising:
a light interrupter provided at the inner side of a first cavity of a main cavity body of the magnetic pump, wherein a rotating shaft passes through a penetrating hole provided at one end of the main cavity body, and a first opening is provided at the other end of the main cavity body;
at least a light interrupting element that is brought into rotation by the rotating shaft in the first cavity to interrupt a light source provided by the light interrupter at a specific period and allowing the light interrupter to generate at least one periodic signal based on periodic change of light source interruption; and
a control circuit electrically coupled with the light interrupter to receive the at least one signal and perform a measuring process.

8. The measuring module for a magnetic pump of claim 7, wherein the specific period is calculated from rotation angle of the rotating shaft, wherein the specific period further includes 360°, 180°, 120° and 90°.

9. The measuring module for a magnetic pump of claim 8, wherein the at least one light interrupting element further includes at least one light interrupting blade for interrupting the light source of the light interrupter during rotation, wherein the at least one light interrupting blade is arranged on the rotating shaft based on the quantity required for achieving the specific period.

10. The measuring module for a magnetic pump of claim 7, the magnetic pump further comprising:
a motor for rotating the rotating shaft;
at least a first magnetic element disposed in the first cavity and fastened around the rotating shaft, wherein the first magnetic element is brought into motion by the rotating shaft;
a partition disposed at the first opening of the main cavity body with a first recess provided in the center of one end of the partition;
a cover provided at one end of the partition with a second cavity provided at the inner side thereof, an inlet at the top end thereof, and an outlet at a side thereof, wherein a third recess is disposed at one end of the inner side thereof, and the third recess corresponds to the first recess;
a magnetic rotating module disposed inside the second cavity of the cover for stirring fluid and receiving a magnetic force of the at least one first magnetic element to generate kinetic energy; and
a central shaft disposed inside the second cavity of the cover around which the rotating element and the magnetic rotating module are fastened, wherein one end thereof is disposed in the first recess, and the other end thereof is disposed in the third recess.

11. The measuring module for a magnetic pump of claim 10, wherein the magnetic rotating module further includes an impeller set or a gear set.

12. The measuring module for a magnetic pump of claim 10, wherein the magnetic rotating module further includes at least one second magnetic element disposed in the second cavity of the cover for receiving the magnetic force of the at least one first magnetic element to generate kinetic energy.

13. A meter-type magnetic pump comprising:
a main cavity body having a first cavity, a penetrating hole provided at one end of the main cavity body, and a first opening provided at the other end of the main cavity body;
a motor including a rotating shaft passing through the penetrating hole;
at least a first magnetic element disposed in the first cavity and fastened around the rotating shaft;
a measuring device that is brought into motion by the rotation of the rotating shaft, such that interruption or passing through of a light source is performed at a specific period, and the measuring device generates a signal based on the specific period in order to performs a measuring process;
a partition disposed at the first opening of the main cavity body with a first recess provided in the center of one end of the partition;
a cover provided at one end of the partition with a second cavity provided at the inner side thereof, an inlet at the top end thereof, an outlet at a side thereof, and a third recess at one end of the inner side thereof, the third recess corresponding to the first recess;
a rotating element disposed inside the second cavity of the cover for stirring fluid;
a magnetic rotating module disposed inside the second cavity of the cover for stirring fluid and receiving a magnetic force of the at least one first magnetic element to generate kinetic energy; and
a central shaft disposed inside the second cavity of the cover around which the rotating element and the magnetic rotating module are fastened, wherein one end thereof is disposed in the first recess, and the other end thereof is disposed in the third recess.

14. A meter-type magnetic pump of claim 13, wherein the measuring device further includes:
a light interrupter provided at the inner side of the first cavity;
at least a light interrupting element that is brought into rotation by the rotating shaft to interrupt the light source provided by the light interrupter at a specific period to allow the light interrupter to generate the signal based on the specific period for light source interruption; and
a control circuit electrically coupled with the light interrupter to receive the periodic signal and perform the measuring process.

15. The meter-type magnetic pump of claim 14, wherein the specific period is calculated from rotation angle of the rotating shaft, wherein the specific period further includes 360°, 180°, 120° and 90°.

16. The meter-type magnetic pump of claim 15, wherein the at least one light interrupting element further includes at least one light interrupting blade for interrupting the light source of the light interrupter during rotation, wherein the at least one light interrupting blade is arranged on the rotating shaft based on the quantity required for achieving the specific period.

17. The meter-type magnetic pump of claim 14, wherein the control circuit performs the measuring process to generate a control signal and controls the actuation of the magnetic rotating module to facilitate regulation of the amount of fluid released.

18. The meter-type magnetic pump of claim 13, wherein the magnetic rotating module further includes an impeller set or a gear set.

19. The meter-type magnetic pump of claim 13, wherein the magnetic rotating module further includes at least one second magnetic element disposed in the second cavity of the cover for receiving the magnetic force of the at least one first magnetic element to generate kinetic energy.
